(19) United States
(12) Patent Application Publication
(10) Pub. No.: US 2015/0174762 A1
(43) Pub. Date: Jun. 25, 2015

(54) SAFE JOINT APPARATUS FOR ROBOT

(71) Applicant: Hyundai Motor Company, Seoul (KR)

(72) Inventor: Hun Keon Ko, Seoul (KR)

(21) Appl. No.: 14/325,895

(22) Filed: Jul. 8, 2014

(30) Foreign Application Priority Data
Dec. 23, 2013 (KR) 10-2013-0161881

(51) Int. Cl. B25J 9/16

(52) U.S. Cl. CPC B25J 9/1674; Y10S 901/28; Y10S 901/49

(57) ABSTRACT

A safe joint apparatus for a robot is provided and includes a pipe-shaped fixture with a hollow and a rotating member rotatably inserted into the hollow of the fixture. In addition, a plurality of elastic members are each fixed to the fixture on a first side thereof and a coupler on a second side thereof to form a predetermined angle. The coupler is provided for the rotating member.

### CROSS REFERENCE TO RELATED APPLICATION

The present application claims priority of Korean Patent Application Number 10-2013-0161881 filed Dec. 23, 2013, the entire contents of which application is incorporated herein for all purposes by this reference.

### BACKGROUND

1. Field of the Invention

The present invention relates, in general, to a safe joint apparatus for a robot and, more particularly, to a safe joint apparatus for a robot that protects a joint of the robot upon collision.

2. Description of the Related Art

With the expansion of an application range of robots as well as the development of various techniques, service robots have become more developed and widely used. Such service robots typically include: robots used in non-manufacturing industries such as medical care, welfare, construction; robots used in high-risk working environments; and personal robots that are human-friendly support robots. Such robots are expected to exhibit more various forms in the future.

Meanwhile, a prerequisite condition required when robots such as service robots and humanoid robots and humans coexist is “human safety.” However, with the increase in activity spaces which humans share with robots, unintentional interference may occur, possibly leading to accidents. Various research for satisfying both safety and performance is currently being actively conducted to improve the safety of these robots. For the purpose of securing safety in this way, research on variable stiffness units is being conducted. However, most safe joint mechanisms are limited to application to commercialized robots due to size, weight, and complexity of control. Further, mechanisms for preventing collisions that may cause damage using an electronic active control system generally require a relatively expensive sensor module and a complex control algorithm. Further, response speed is dependent on sensitivities of a sensor and an actuator.

A safe joint apparatus for a robot in the related art includes a fixture, and a rotating unit that is rotatably coupled to the fixture. The rotating unit includes a cam unit installed to protrude from the center of the rotating unit. The fixture includes a plurality of followers, each of which is rotatably coupled at one end thereof and comes into contact with the cam unit at the other end thereof; and elastic units that apply an elastic force to the followers to restrict rotational motion of the rotating unit. When a force equal to or greater than critical torque is applied to the rotating unit, the cam unit is separated from the followers. However, the safe joint apparatus has a complex structure, and is difficult to control.

The foregoing is intended merely to aid in the understanding of the background of the present invention, and is not intended to mean that the present invention falls within the purview of the related art that is already known to those skilled in the art.

### SUMMARY

Accordingly, the present invention provides a safe joint apparatus for a robot that provides a simplified structure, and minimizes damage to the robot and as well as its counterpart upon collision.

In order to achieve the above object, according to one aspect of the present invention, a safe joint apparatus for a robot may include: a pipe-shaped fixture formed with a hollow (e.g., an aperture through the fixture); a rotating member rotatably inserted into the hollow of the fixture; and elastic members, each of which may be fixed to the fixture on a first side thereof and a coupler on a second side thereof to form a predetermined angle. The coupler may be provided for the rotating member.

In particular, the fixture may have threads formed on an inner circumferential surface thereof, and the rotating member may have threads formed on an outer surface thereof, causing the threads of the fixture and the threads of the rotating member to mesh with each other. Further, the rotating member may have a bar shape, and include a support that crosses the fixture. In addition, the support may have opposite ends formed along the fixture in an arc shape and come into close contact with the fixture. The rotating member may include a plurality of supports and each support may have a cross-shaped top. The rotating member may have an extension formed to extend in a downward direction and may have a transverse cross section of a ‘T’ shape. Further, the elastic members may be coupled to both sides of the rotating member. When a shock occurs, the rotating member may be linearly moved by the threads along with rotational motion. The coupler may have a bar shape formed in a vertical direction, and may be pulled toward the rotating member by the elastic member. In addition, a plurality of stoppers may be formed on a lower side of each of the coupler, and the couplers may come into contact with stoppers to be prevented from moving toward each other.

According to the safe joint apparatus for a robot having the structure as described above, the elastic members may be fixed at a predetermined angle and may provide the apparatus with variable stiffness, thereby absorbing a shock upon collision. Such variable stiffness may be obtained by adjusting the angle of the elastic members. Accordingly, a degree of freedom of design may be increased, and the shock may be further absorbed. Thus, substantially smooth shock absorption may be possible and the joint of the robot may be safely protected from an external shock. Minimum mechanical components may be used to accomplish a simple structure, reduce space, simplify maintenance, and reduce costs. The safe joint apparatus may be directly applied to the joint of the robot. Further, the safe joint apparatus may be applied to safe hinges of a vehicle, and a modular joint driving mechanism including the safe joints can be developed.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 shows an exemplary safe joint apparatus for a robot according to an exemplary embodiment of the present invention;

FIGS. 2 and 3 show exemplary states in which the rotating member of FIG. 1 is rotated counterclockwise and clockwise according to an exemplary embodiment of the present invention;

FIG. 4 shows an exemplary graph of variable stiffness according to an exemplary embodiment of the present invention;

FIG. 5 shows an exemplary graph when the safe joint apparatus is applied to a robot according to an exemplary embodiment of the present invention; and

FIGS. 6 and 7 show an exemplary conventional safe joint apparatus for a robot according to the related art.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the tem “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

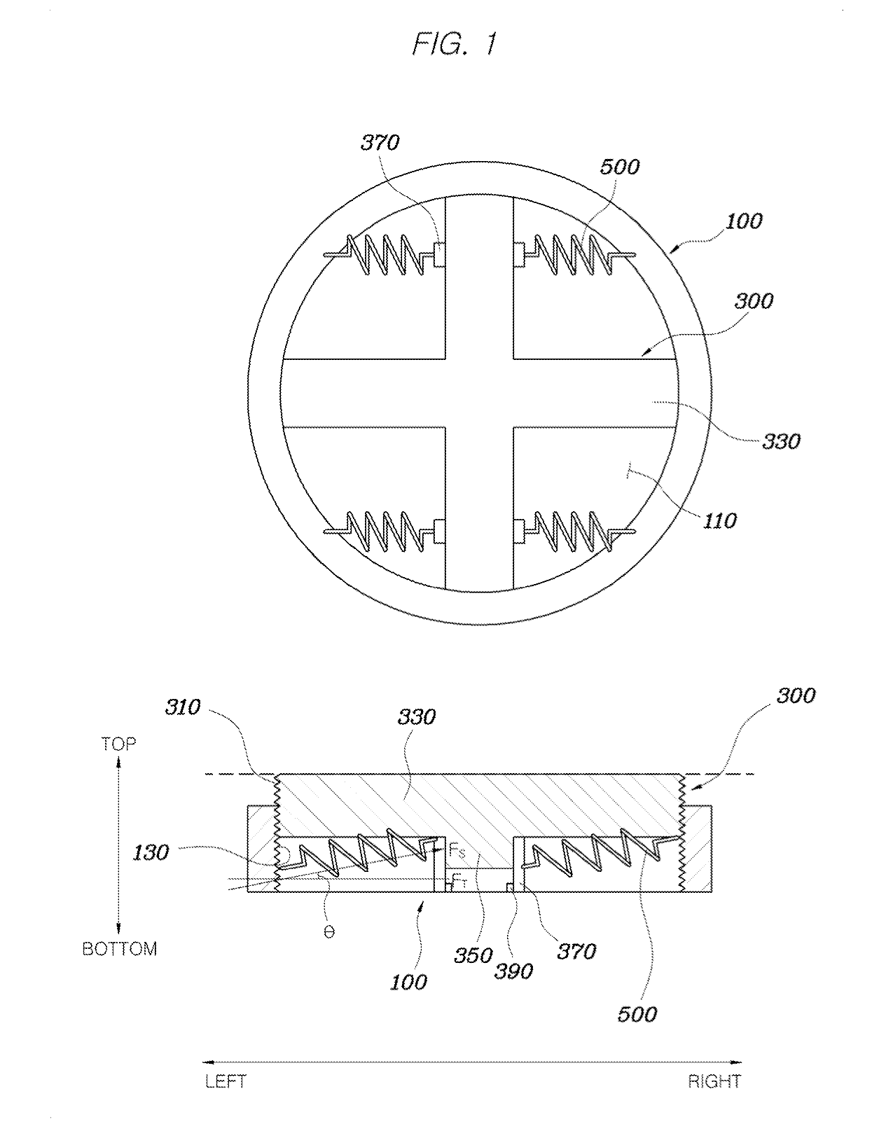

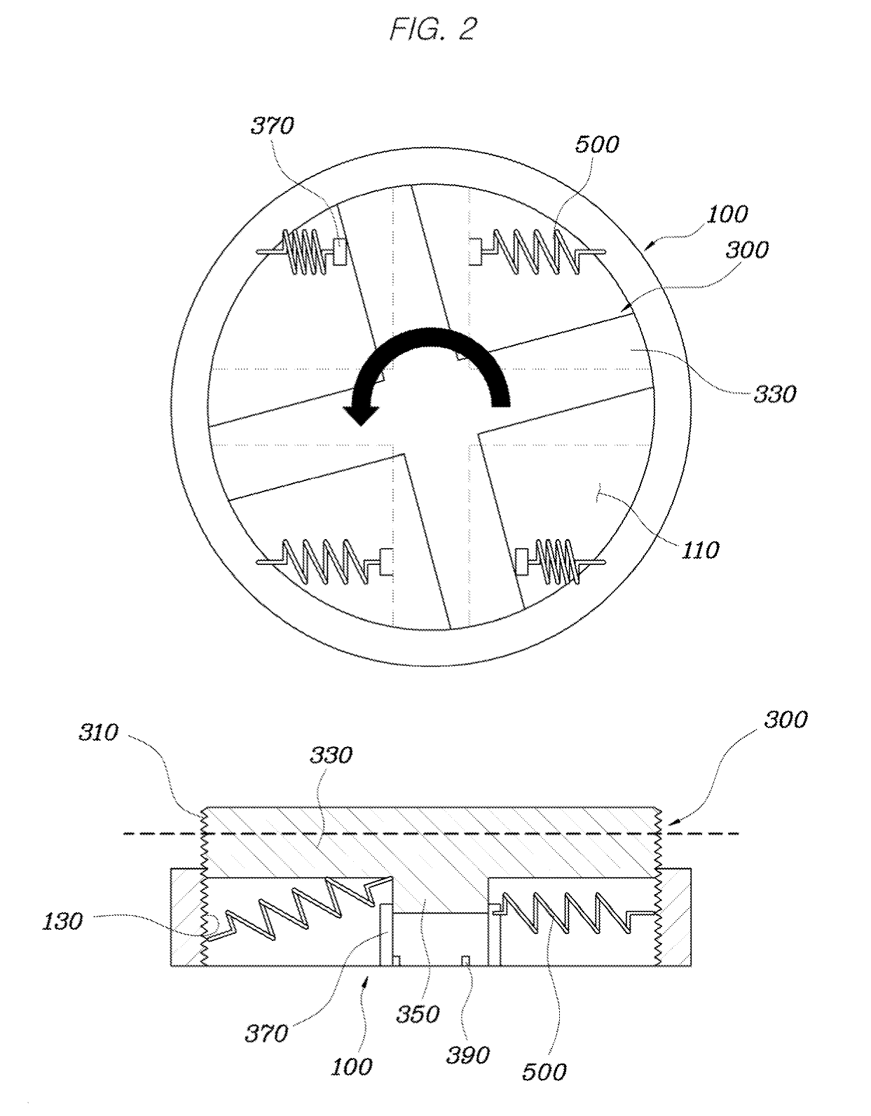

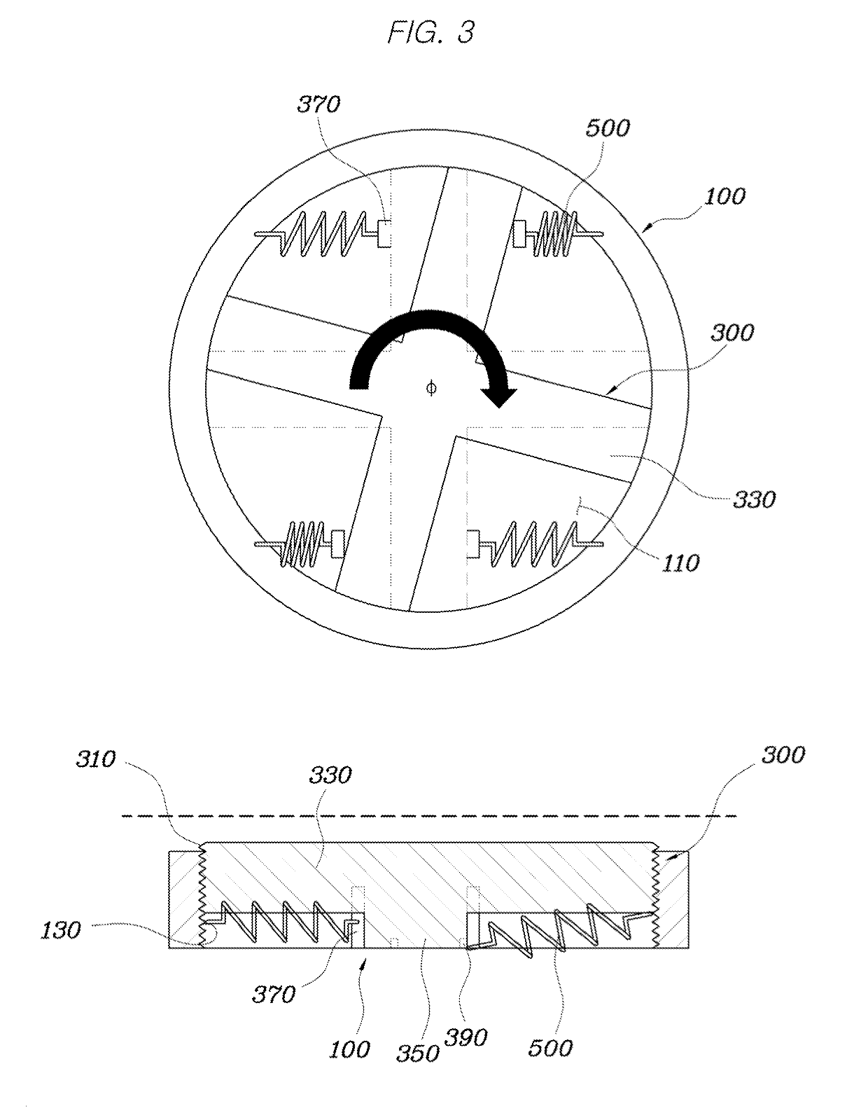

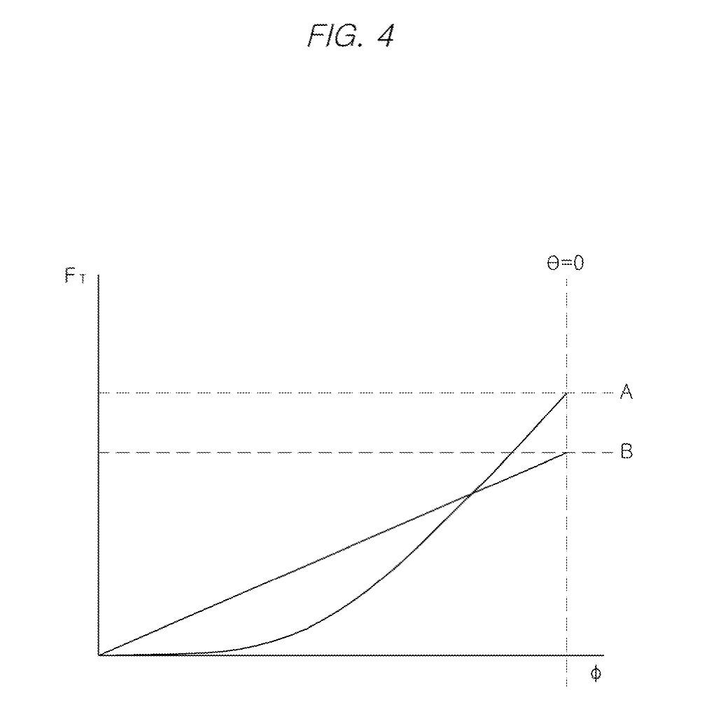

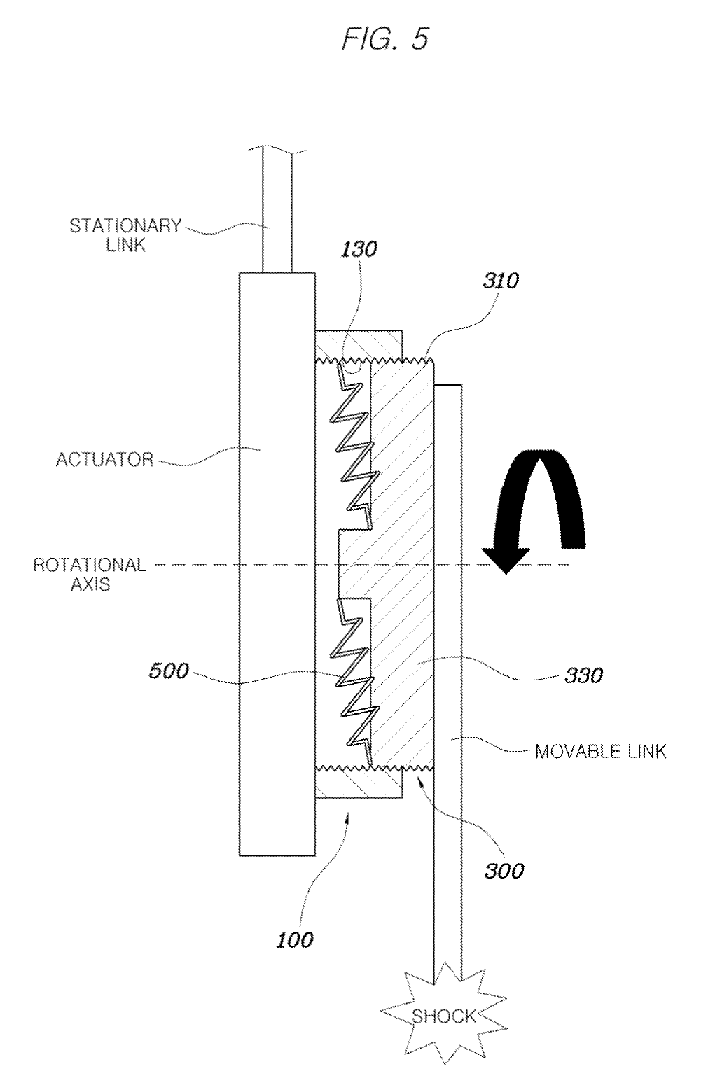

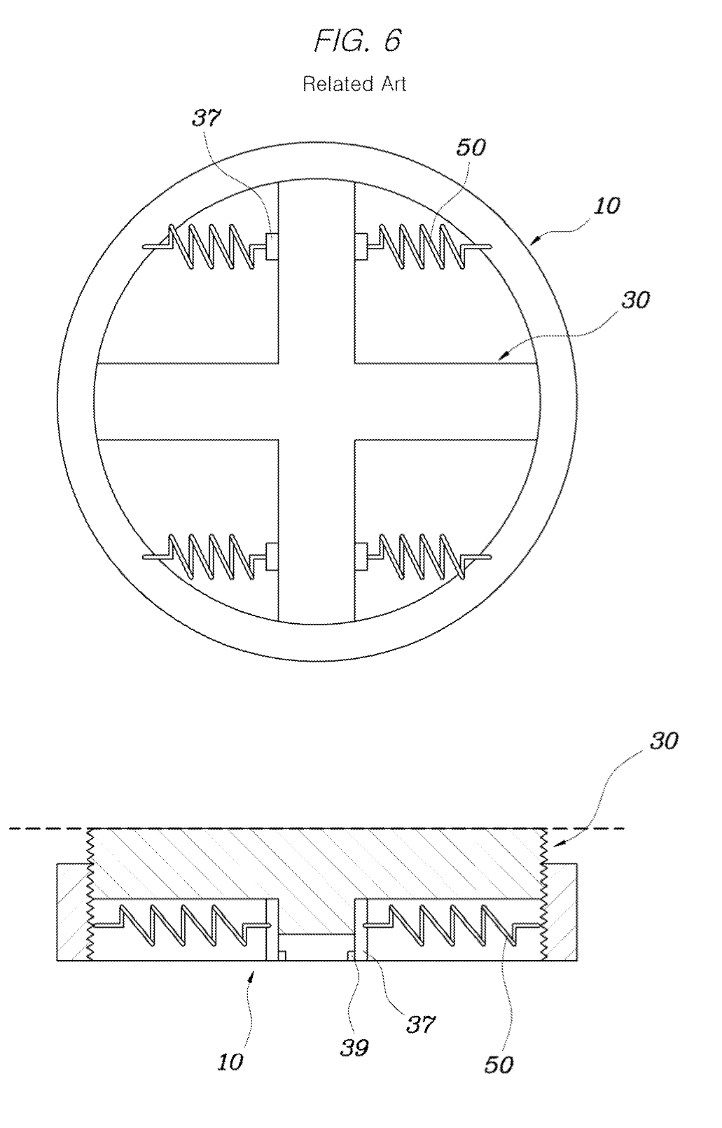

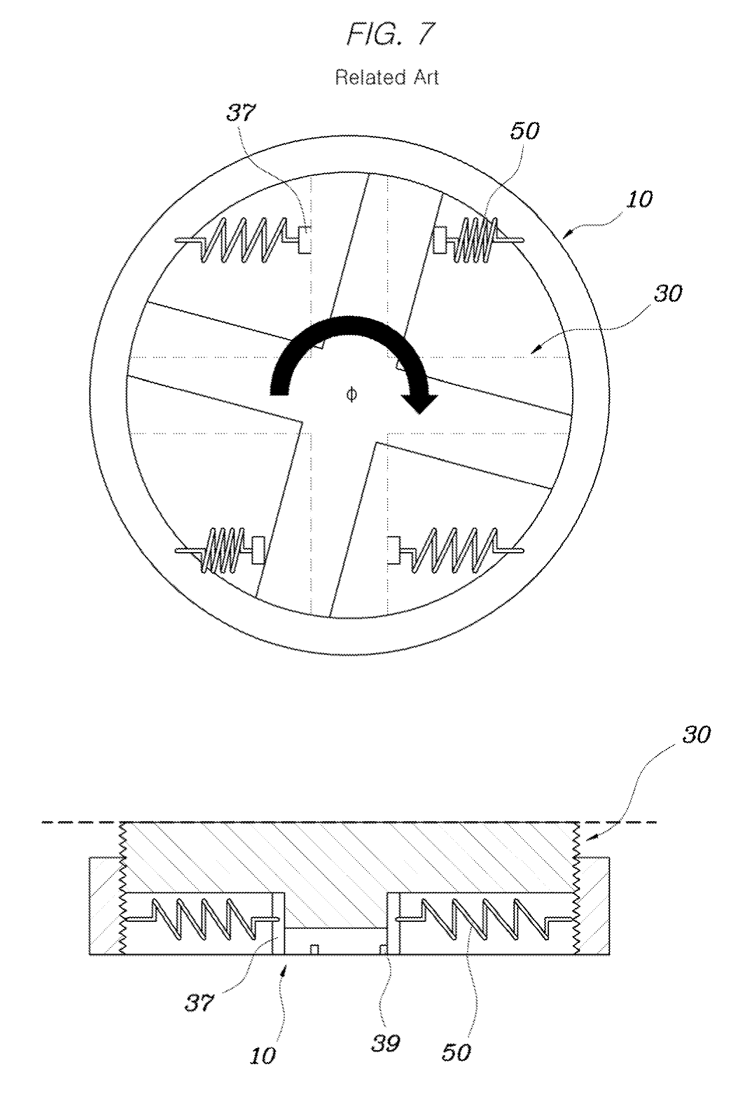

Hereinbelow, a safe joint apparatus for a robot according to an exemplary embodiment of the present invention will be examined in detail with reference to the accompanying drawings. FIG. 1 shows an exemplary safe joint apparatus for a robot according to an exemplary embodiment of the present invention. FIGS. 2 and 3 show exemplary states in which the rotating member of FIG. 1 is rotated counterclockwise and clockwise. FIG. 4 shows an exemplary graph of variable stiffness. FIG. 5 shows an exemplary graph when the safe joint apparatus is applied to the robot. In addition, FIGS. 6 and 7 show an exemplary conventional safe joint apparatus for a robot.

A safe joint apparatus for a robot according to an exemplary embodiment of the present invention may include: a pipe-shaped fixture 100 formed with a hollow 110 (e.g., an aperture through the fixture); a rotating member 300 rotatably inserted into the hollow 110 of the fixture 100; and a plurality of elastic members 500, each of which may be fixed to the fixture 100 on a first thereof and a coupler 370 on a second side thereof to form a predetermined angle θ, wherein the coupler 370 may be provided for the rotating member 300.

In addition, the fixture 100 may be of a predetermined height and may have a shape of a pipe with the hollow 110, and the rotating member 300 may be coupled to the hollow 110. The rotating member 300 may include an upper support 330 and a lower extension 350. The support 330 of the rotating member 300 may have a bar shape, and may be formed to cross the fixture 100, in particular, so that the support 330 passes the central axis of the fixture 100. Further, an end of the support 330 may be formed along an inner circumferential surface of the fixture 100 in an arc shape, and may be vertically inserted into or extracted from the inside of the fixture 100 by a predetermined depth. The inner circumferential surface of the fixture 100 may include a plurality of threads 130, and an outer surface of the rotating member 300 may include a plurality of threads 310. The threads 130 of the fixture 100 and the threads 310 of the rotating member 300 may be meshed with each other. Thus, vertical linear motion according to rotation of the rotating member 300 may be more systematically performed.

Furthermore, a plurality of supports 330 may be formed. In the exemplary embodiment, two supports 330 may be formed to have an angle of about 90 degrees with respect to each other. Thus, the two supports 330 may be formed with the top thereof having a cross shape. In addition, the rotating member 300 may have the extension 350 formed to extend downward therefrom, and a transverse cross-section of the rotating member 300 may have a ‘T’ shape. Accordingly, the extension 350 may function as the substantial center of gravity when the rotating member 300 is rotated by collision.

Each elastic member 500 may be coupled to the fixture 100 and the rotating member 300. As shown in FIG. 1, a first end of the elastic member 500 may be fixed to a lower side of the fixture 100, and a second end of the elastic member 500 may be fixed to an upper side of the coupler 370 provided for the rotating member 300. Accordingly, the elastic member 500 may have a predetermined angle θ with respect to the bottom of the fixture 100. Alternatively, such a predetermined angle θ may be determined according to a position at which the elastic member 500 is coupled. For example, the elastic member 500 may be coupled to an upper side of the fixture 100 and a lower side of the coupler 370. The elastic members 500 may be coupled to both sides of each support 330 of the rotating member 300. However, in the exemplary embodiment, it is merely shown that the elastic members 500 are coupled to the couplers 370 disposed at both sides of each support 330 of the rotating member 300. However, this structure may be changed with no limitation according to a design and an environment.

Each coupler 370 may be vertically formed in a bar or plate shape. The couplers 370 may be pulled toward the rotating member 300 by the elastic members 500, and may be elastically supported. A stopper 390 may be formed on a lower side of each coupler 370, and may extend toward the extension 350, to prevent each coupler 370 from being narrowed within a predetermined distance. In addition, when the rotating member 300 is rotated due to a shock, the couplers 370 may be pressed and pushed in the rotation direction by the extension 350, and thus the elastic members 500 may be compressed. It is shown in FIG. 1 that the couplers 370 may move in parallel. However, the couplers 370 may be designed to come into close contact with the rotating member 300 and to move to have about the same angle as the rotating member 300.

FIG. 2 shows a state in which the rotating member 300 is rotated counterclockwise by a predetermined angle Φ. As seen from FIG. 2, the rotating member 300 may be rotated counterclockwise by a shock applied in a normal state of FIG. 1, and the rotating member 300 may be linearly moved upward by the threads 130 of the fixture 100 and the threads 310 of the rotating member 300. In comparison with a reference line of FIG. 1, the top of the support 330 of the rotating member 300 may move upward relative to the top of the support 330 in the normal state.

As a result of the above-mentioned movement, the elastic members 500 disposed at an upper right side and a lower left side with respect to the central axis of the rotating member 300 may be maintained in a shock-free state, i.e. in the normal state, by the couplers 370, and the rotating member 300 moves up. However, the elastic members 500 disposed at an upper left side and a lower right side may be compressed due to the rotational motion and the linear motion of the rotating member 300, compared to those maintained in the normal state, and thus an angle less than the predetermined angle θ (which is illustrated as an angle of almost 0 degrees to be easily understood in the drawing) may be formed. Accordingly, an amount of shock absorption may increase.

In contrast to FIG. 2, FIG. 3 shows a state in which the rotating member 300 is rotated clockwise by a predetermined angle (D. As can be seen from FIG. 3, the rotating member 300 may be rotated clockwise by a shock applied in the normal state of FIG. 1, and the rotating member 300 may be linearly moved downward by the threads 130 of the fixture 100 and the threads 310 of the rotating member 300. In comparison with the reference line of FIG. 1, the top of the support 330 of the rotating member 300 may move downward relative to the top of the support 330 in the normal state.

As a result of the above-mentioned movement, the elastic members 500 disposed at the upper left side and the lower right side with respect to the central axis of the rotating member 300 may be maintained in the normal state by the couplers 370, and the rotating member 300 may move in a downward direction. However, the elastic members 500 disposed at the upper right side and the lower left side may be compressed due to the rotational motion and the linear motion of the rotating member 300, compared to those maintained in the normal state, and thus an angle less than the predetermined angle θ (which is illustrated as an angle of almost 0 degrees to be easily understood in the drawing) may be formed. Accordingly, an amount of shock absorption may increase.

As seen from FIGS. 2 and 3, when the shock occurs, the rotating member 300 exhibits a variable stiffness characteristic by the elastic members 500 formed at the predetermined angle θ to cause the rotating member 300 to be linearly moved by the threads along with the rotational motion caused by the shock, and thus smoother shock absorption and space-efficient shock absorption may be possible. In addition, an amount of compression of the elastic members 500 may increase compared to the related art, and thus the amount of shock absorption may be increased.

A restoring force of the elastic member 500 applied in a torque direction to offset the shock may be a transverse force, and may be defined as F_{T}, since the elastic member 500 may have a predetermined angle θ with respect to the bottom of the fixture 100. A restoring force of the elastic member 500 applied in a longitudinal direction may be defined as F_{S}. Then, cos θ=F_{T}/F_{S}. As such, a value of F_{T} that is the restoring force may be obtained by an equation of F_{T}=F_{S} cos θ. As shown in FIG. 4, based on the equation, the restoring force of the elastic member 500 of the present invention does not exhibit existing linear characteristics B, but exhibits a behavior of a cosine curve of graph A.

FIG. 5 shows a state in which the safe joint apparatus is applied to a robot. When a shock is applied to a movable link of the robot during rotational motion, a reaction shock having about the same strength as the applied shock may be applied to a counterpart collided with the robot due to the law of action and reaction. Since the restoring force of conventional elastic members 50 have the linear behavior B, the conventional elastic members 50 may have a less amount of shock absorption than those of the present invention upon collision. Thus, a stronger shock may be applied to the joint of the conventional robot, and the reaction shock may be equally transmitted to the counterpart of the robot. As such, both the robot and the counterpart may be damaged.

However, in the safe joint apparatus for a robot according to an exemplary embodiment of the present invention, the elastic members 500 may be fixed at a predetermined angle to have variable stiffness. Accordingly, smoother shock absorption than in the related art may be possible upon collision. In addition, since desired stiffness may be provided by adjusting the angle of the elastic members 500, the safe joint apparatus may be designed to have a variable stiffness. Therefore, a degree of freedom of the design may increase, and the shock may be minimized by the variable stiffness. Thus, smoother shock absorption may be possible, and the joint of the robot may be more safely protected from an external shock. There are advantages in that minimum mechanical components may be used to accomplish a simplified structure and also reduce installation space, simplify maintenance, and reduce costs. Additionally, the safe joint apparatus may be directly applied to the joint of the robot.

In a conventional safe joint mechanism shown in FIGS. 6 and 7, elastic members 50 are coupled between couplers and a fixture 10 at the same height. When a shock occurs, a rotating member 30 is merely rotated in the fixture 10, and thus the shock is absorbed by a linear restoring force B that is a unique characteristic of the elastic members 50.

However, in the safe joint apparatus for a robot according to an exemplary embodiment of the present invention, the elastic members 500 may be coupled to form a predetermined angle θ. When a shock occurs, the rotating member 300 may be subject to the vertical linear motion along with the rotational motion. As the restoring force exhibits the behavior having the characteristic of the cosine curve of graph A, the safe joint apparatus may have a greater amount of shock absorption than that of the conventional structure. There is an advantage in which stiffness may be varied by changing the angle formed by the elastic member 500, and thus smoother shock absorption may be possible. In addition, there is an advantage in that the safe joint apparatus may be applied to safe hinges of a vehicle, and a modular joint driving mechanism including the safe joints may be developed.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A safe joint apparatus for a robot comprising:
a pipe-shaped fixture formed with a hollow;
a rotating member rotatably inserted into the hollow of the fixture; and
a plurality of elastic members, wherein each elastic member is fixed to the fixture on a first side thereof and a coupler on a second side thereof to form a predetermined angle, the coupler being provided for the rotating member.

2. The apparatus according to claim 1, wherein the fixture has a plurality of threads formed on an inner circumferential surface of the fixture, and the rotating member has a plurality of threads formed on an outer surface of the rotating member, to mesh the threads of the fixture and the threads of the rotating member.

3. The apparatus according to claim 1, wherein the rotating member has a bar shape, and includes a support crossing the fixture.

4. The apparatus according to claim 3, wherein the support has opposite ends that are formed along the fixture in an arc shape and come into contact with the fixture.

5. The apparatus according to claim 3, wherein the rotating member includes a plurality of supports.

6. The apparatus according to claim 3, wherein the support has a cross-shaped top.

7. The apparatus according to claim 3, wherein the rotating member has an extension formed to extend in a downward direction.

8. The apparatus according to claim 7, wherein the rotating member has a transverse cross section of a “T” shape.

9. The apparatus according to claim 3, wherein the elastic members are coupled to both sides of the rotating member.

10. The apparatus according to claim 1, wherein, when a shock occurs, the rotating member is linearly moved by the threads along with rotational motion.

11. The apparatus according to claim 1, wherein the coupler has a bar shape formed in a vertical direction, and is pulled toward the rotating member by the elastic member.

12. The apparatus according to claim 11, wherein a plurality of stoppers are formed on a lower side of each coupler, and the couplers come into contact with the stoppers to be prevented from moving toward each other.
